(19) United States
(12) Patent Application Publication
(10) Pub. No.: US 2007/0179633 A1
(43) Pub. Date: Aug. 2, 2007

(54) Terminal device

(75) Inventors: Goichi Ono, Soka (JP); Tatsuo Nakagawa, Hachioji (JP); Masayuki Miyazaki, Tokyo (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/656,444

(22) Filed: Jan. 23, 2007

(30) Foreign Application Priority Data
Jan. 27, 2006 (JP) 2006-018363

(51) Int. Cl. G05B 11/01

(52) U.S. Cl. 700/12

(57) ABSTRACT

Power supply voltages delivered to processing units of a terminal device, respectively, and a delivery range of the power supply voltages are changed over. There is provided the terminal device comprising a connecter for connecting power supply boards for delivering respective power supply voltages thereto, a plurality of processing units to be operated by the respective power supply voltages delivered from the power supply boards, wherein by connecting the respective power supply boards differing in circuit structure from each other with the connecter, the processing units to which the respective power supply voltages are delivered and levels of the respective power supply voltages as delivered are changed over.

### CLAIM OF PRIORITY

The present application claims priority from Japanese application JP 2006-018363 filed on Jan. 27, 2006, the content of which is hereby embedded by reference into this application.

### FIELD OF THE INVENTION

The present invention relates to control on a delivery range of power supplies suppried to a terminal device, and voltage levels of the power supplies.

### BACKGROUND OF THE INVENTION

There is a sensor net system for detecting predetermined information by means of a sensor net terminal to thereby carry out data communication with a base station {refer to, for example, “Low power protocol with intermittent communication for sensor network systems” by A. Maeki, et al., Proceedings of International Technical Conference on Circuits/Systems, Computers and Communications (ITC-CSCC) 2005}. The sensor net terminal comprises a sensor, a microcomputer with a communication circuit for executing data communication, a timer, and so forth. Further, batteries for supplying power supply to those components, respectively, are mounted in the sensor net terminal. Since all the components mounted in the sensor net terminal described as above are operated at an identical power supply voltage, the batteries of one type only are mounted in the sensor net terminal.

Meanwhile, with a device comprising a system board and interface boards, there is available a technology for altering a control signal voltage of a ROM by interchanging the interface boards (refer to, for example, JP-A No. 244879/1997. The system board is connected to the interface boards via a connecter. The interface board is provided with a board with a signal line connected to a ground potential, and a board with a signal line that is open-ended. A CPU and a ROM are mounted-in the system board and by altering the control signal voltage of the ROM through the interchange of the interface boards, a read address of the ROM is controlled.

### SUMMARY OF THE INVENTION

A sensor net terminal has several operation modes including a mode for causing it to operate as a terminal, a mode for writing a program for operating the terminal to a microcomputer, a mode for debugging, and so forth. With a conventional sensor net terminal, for example, as described in the foregoing, all the operation modes were operated by the same power supply.

However, in order to reduce power consumption at the sensor net terminal, it is desirable to operate the terminal at a power supply voltage lower than a present power supply voltage, and it is required to alter the power supply voltage according to the respective operation modes. This is because the terminal can be operated at a low voltage in the mode for operating the terminal, but in the mode for writing a terminal operation program to a flash memory embedded in the microcomputer, the same high voltage as required in the past is necessary, so that it is not allowed to render the power supply voltage lower than the voltage adopted in the past. Further, because an operation voltage of the sensor normally varies on a sensor-by-sensor basis, and the sensor for use in the sensor net terminal varies by the system, there arises the need for altering the power supply voltage on a system-by-system basis. Furthermore, because the sensor net terminal includes components not requiring power supply depending on the operation mode, such as, for example, the sensor at the time of program-writing, it is also required to selectively deliver power supplies, thereby reducing power consumption.

Still further, there is a technology whereby a signal voltage on the system board can be altered by interchanging the interface boards, however, with this technology, it is not possible to alter a power supply to one at a plurality of voltages according to an operation mode required of the terminal, and to selectively deliver the power supply to constituent components of a terminal. This is because the power supply is mounted on the system board, so that components on the system board have a power supply voltage in common with each other and through the interchange of the interface boards, only either the power supply voltage or the ground potential can be used for the power supply.

The present invention has been developed in order to resolve the problems described as above, and it is an object of the invention to provide a terminal device capable of changing respective power supply voltages delivered from power supply boards to components mounted in the terminal device simply by interchanging the power supply boards according to an operation mode of the terminal device, and changing a delivery range of the power supply voltages.

A representative embodiment of the invention is disclosed as follows.

In accordance with one aspect of the invention, there is provided a terminal device comprising a connecter for connecting power supply boards for delivering respective power supply voltages thereto, a plurality of processing units to be operated by the respective power supply voltages delivered from the power supply boards, wherein by connecting the respective power supply boards differing in circuit structure from each other with the connecter, the processing units to which the respective power supply voltages are delivered and levels of the respective power supply voltages as delivered are changed over.

The invention has advantageous effects in that the processing units of the terminal device to which the respective power supply voltages are delivered, and the levels of the respective power supply voltages as delivered can be changed over by interchanging the power supply boards. Furthermore, it is possible to prevent the processing from being destructed in case a wrong power supply board is connected to the connecter.

### BRIEF DESCRIPTION OF THE DRAWINGS

FIG. 1 is a block diagram showing a configuration of a first embodiment of the invention;

FIG. 2 is a view showing a structure of a sensor net terminal as well as a base station according to the first embodiment of the invention;

FIG. 3 is a block diagram showing a configuration of a second embodiment of the invention;

FIG. 4 is a view showing logic levels of a power supply voltage determination means according to the second embodiment of the invention;

FIG. 5 is a block diagram showing a configuration of a third embodiment of the invention;

FIG. 6 is a view showing a structure of a sensor net terminal as well as a base station according to the third embodiment of the invention;

FIG. 7 is a block diagram showing a configuration of a fourth embodiment of the invention; and

FIG. 8 is a view showing logic levels of a power supply voltage determination means according to the fourth embodiment of the invention.

### DETAILED DESCRIPTION OF THE PREFERRED EMBODIMENTS

Embodiments of the invention are described in detail hereinafter.

### Embodiment 1

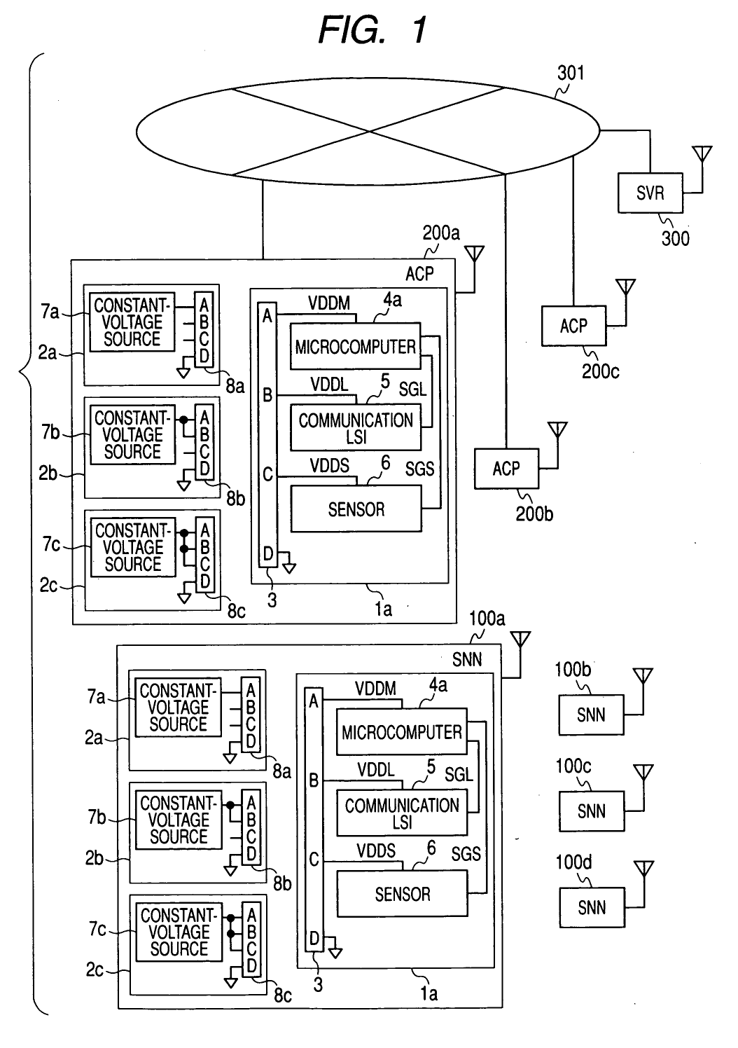

FIG. 1 is a block diagram showing a first embodiment of the invention. First, a sensor net system is described. The sensor net system comprises an infinite number of small-sized sensor net terminals each provided with a sensor, a microcomputer, wireless communication, power supplies, and so forth, and the respective sensor net terminals take measurements on conditions of individuals, environments, and so forth, autonomously making up a network. The sensor net system according to the first embodiment is made up of at least one sensor net terminal (SNN) 100 (100a, 100b, 100c, 100d, . . . ), a plurality of base stations (ACP) 200 (200a, 200b, 200c, . . . ), a server (SVR) 300, and a network 301. It is to be understood that in the present specification, reference numerals with suffixes a, b, c, d, . . . , respectively, attached thereto, denote identical elements, respectively, and reference numerals without the respective suffixes attached thereto indicate the identical elements, respectively. The plurality of the base stations (ACP) 200 make up the network 301 and the server (SVR) 300 is connected thereto. The sensor net terminal (SNN) 100 transmits data as acquired or generated to the base station (ACP) 200. The base station (ACP) 200 receives transmit data from the sensor net terminal (SNN) 100, and sends out receive data to the server (SVR) 300 via the network 301. The server (SVR) 300 executes processing and control of the data from the base station (ACP) 200. A structure of the sensor net terminal (SNN) 100 will be described later on, and for the base station (ACP) 200, use may be made of the same hardware structure as that for the sensor net terminal (SNN) 100.

Now, the structure of the sensor net terminal (SNN) 100 is described hereinafter. As shown in FIG. 1, a terminal device 1a according to the invention is provided with a connecter 3 and a plurality of processing units. With the present embodiment, there is described the terminal device provided with three processing units, namely, a microcomputer 4a, a communication controller 5, and a sensor 6, as the plurality of the processing units. Further, with the present embodiment, the communication controller is implemented by use of a communication LSI. The connecter 3 comprises four terminals A, B, C, D. Respective power supplies VDDM, VDDL, and VDDS for the microcomputer 4a, the communication LSI 5, and the sensor 6 are connected to the terminals A, B, and C of the connecter 3 via individual power supply lines, respectively. Further, the ground potential of the terminal device 1a is connected to the terminal D of the connecter 3. Signal lines SGL, SGS are connected from the microcomputer 4a to the communication LSI 5, and the sensor 6, respectively.

Power supply boards 2a, 2b, 2c are provided with connecters 8a, 8b, 8c, and constant-voltage sources 7a, 7b, 7c, respectively. The constant-voltage sources 7a, 7b, 7c output respective voltages differing from each other, but may output the same voltage. With the present embodiment, the constant-voltage sources 7a, 7b, 7c output 3V, 2.5V, and 1.8V, respectively. The connecters 8a, 8b, 8c each comprise four terminals A, B, C, D as with the connecter 3, so as to pair off with the connecter 3, respectively. The respective terminals D of the connecters 8a, 8b, 8c are connected to the respective ground potentials of the power supply boards 2a, 2b, 2c. Further, a part to which the remaining terminals A, B, C are connected, respectively, differ among the power supply boards 2a, 2b, 2c, and there is adopted a structure where the terminals A, B, C are either connected to the constant-voltage sources 7a, 7b, 7c, respectively, or to none of the constant-voltage sources 7a, 7b, 7c, as shown in FIG. 1.

The connecter 3 is connected to only one of the connecters 8a, 8b, 8c at a time. Accordingly, it is only one of the power supply boards 2a, 2b, 2c that can be connected to the terminal device 1a at a time.

The terminals A, B, C, D of the connecter 3 are connected to the terminals A, B, C, D of the connecters 8a, 8b, 8c, respectively, on an one-on-one basis.

The power supply boards 2a, 2b, 2c are power supply boards corresponding to respective operation modes of the terminal device, and by interchanging the power supply boards for every operation mode, it is possible to change over the processing units of the terminal device 1a, to which power supply is delivered from the power supply boards 2a, 2b, 2c, respectively, and voltage levels of the power supply as delivered. With the present embodiment, the operation modes are three modes including a program-write mode, a base station mode, and a sensor net terminal mode. The program-write mode is a mode for writing to a nonvolatile memory embedded in the microcomputer 4a. Accordingly, in the program-write mode, it is sufficient for power supply to be delivered only to the microcomputer 4a among the processing units of the terminal device 1a, and a power supply voltage as required is 3V. The base station mode is a mode for operating the terminal device as the base station (ACP) 200 shown in FIG. 1. Since the base station mode is a mode for receiving data transmitted from the sensor net terminal to be connected to the network, there is no need for operating the sensor. Accordingly, the power supply is required for the microcomputer 4a, and the communication LSI 5 among the processing units of the terminal device 1a, and a voltage thereof is 2.5V. The sensor net terminal mode is a mode for operating the terminal device as the sensor net terminal for detecting information, and transmitting data on the information to the base station. Accordingly, the power supply is required for all the processing units of the terminal device 1a, and a voltage thereof is 1.8V.

Next, there are described hereinafter power supply voltages delivered to the respective processing units when the power supply boards 2a, 2b, 2c are connected to the terminal device 1a, respectively. In the case of the power supply board 2a being connected to the terminal device 1a, the power supply voltage 3V is delivered from the constant-voltage source 7a to the microcomputer 4a via the terminal A of the connecter 3 and the terminal A of the connecter 8a. Since the constant-voltage source 7a is not connected to the terminals B, C of the connecter 8a, no power supply is delivered to the communication LSI 5, and the sensor 6. In the case of the power supply board 2b being connected to the terminal device 1a, the power supply voltage 2.5V is delivered from the constant-voltage source 7b to the microcomputer 4a and the communication LSI 5 via the terminals A, B of the connecter 3 and the terminals A, B of the connecter 8b. Since the constant-voltage source 7b is not connected to the terminal C of the connecter 8b, no power supply is delivered to the sensor 6. In the case of the power supply board 2c being connected to the terminal device 1a, the power supply voltage 1.8V is delivered from the constant-voltage source 7c to the microcomputer 4a, the communication LSI 5, and the sensor 6 via the terminals A, B, C of the connecter 3 and the terminals A, B, C of the connecter 8c, respectively.

Thus, the sensor net terminal (SNN) 100, and the base station (ACP) 200 each need to selectively provide the terminal device 1a with a plurality of the power supplies according to the operation mode, however, with a configuration according to the present embodiment, the plurality of the power supply boards 2a, 2b, 2c are prepared, and by interchanging them, the power supplies are changed over. In consequence, there is no need for actually mounting a plurality of the power supplies in a power supply board as with the case of the conventional technology, so that the respective power supply boards 2a, 2b, 2c can be implemented in an area of the same size as an area occupied by a power supply board provided with a single power supply. Accordingly, with the sensor net terminal (SNN) 100 according to the invention, it is possible to selectively provide the terminal device 1a with a plurality of the power supplies in size identical to a single power supply. Further, if a terminal is designed according to the structure of the terminal device 1a, as shown in FIG. 1, the same terminal can be operated as the base station (ACP) 200 as well as the sensor net terminal (SNN) 100 by interchanging the power supply boards thereof, thereby enabling the sensor net terminal (SNN) 100 to double as the base station (ACP) 200.

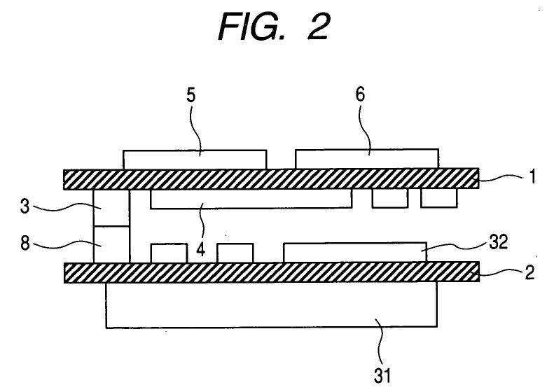

In order to attain reduction in size, with the sensor net terminal (SNN) 100, and the base station (ACP) 200, respectively, the terminal device 1, and the power supply board 2 are disposed so as to form a layered structure via the connecter 3 and the connecter 8 as shown in FIG. 2. With the power supply board according to the conventional technology, it-has been necessary to prepare a plurality of power supplies corresponding to respective operation modes, however, with the adoption of the structure of the power supply board 2, according to the present embodiment, it is sufficient to prepare a single power supply for the power supply board 2, so that an area occupied by the power supply board 2 can be reduced. Accordingly, it is possible to design the power supply board 2 to reside in an area equivalent in size to the terminal device 1, so that the terminal device 1, and the power supply board 2 can be disposed so as to form the layered structure, thereby attaining miniaturization. As shown in FIG. 2, there are mounted the connecter 3, the microcomputer 4a, the communication LSI 5, the sensor 6, and other components on either surface of a substrate of the terminal device 1. Further, there are mounted the connecter 8, a battery 31 as the constant-voltage source 7, a regulator 32, and other components on either surface of the power supply board 2. It is to be pointed out, however, that a layout of the components of the power supply board 2 as well as the terminal device 1 be not limited to that shown in FIG. 2.

Thus, with the terminal device 1, and the power supply board 2 being disposed so as to form the layered structure, a mounting area for the components is increased without causing an increase in bottom face area of the base station (ACP) 200 as well as the sensor net terminal (SNN) 100, thereby attaining further miniaturization of the base station (ACP) 200 as well as the sensor net terminal (SNN) 100. With a sensor net, in particular, installation of a large number of the sensor net terminals (SNN) 100 is required at all sorts of places such as individuals, articles, and so forth. In order to facilitate the installation of the sensor net terminals (SNN) 100, it is desirable that the sensor net terminals (SNN) 100 each are as small in size as possible, and with the adoption of the configuration according to the present application, it is possible to reduce an installation area of the sensor net terminal (SNN) 100. As described in the foregoing, by connecting the power supply boards 2a, 2b, 2c to the terminal device 1a via the connecter 3 and the connecters 8a, 8b, 8c, it is possible to change over the respective processing units of the terminal device 1a, to which the power supply is delivered from the power supply boards 2a, 2b, 2c, respectively, and the voltage levels of the power supply as delivered. Hence, the base station (ACP) 200 as well as the sensor net terminal (SNN) 100 can be implemented by adoption of the same hardware structure, and by interchanging the power supply boards 2a, 2b, 2c, it is possible to effect changeover between the sensor net terminal (SNN) 100, and the base station (ACP) 200. Further, by requiring changeover among the power supply boards to effect changeover between the power supplies to deliver power, it becomes possible to prevent a wrong processing unit from being provided with a voltage level without causing increase in a device configuration.

### Embodiment 2

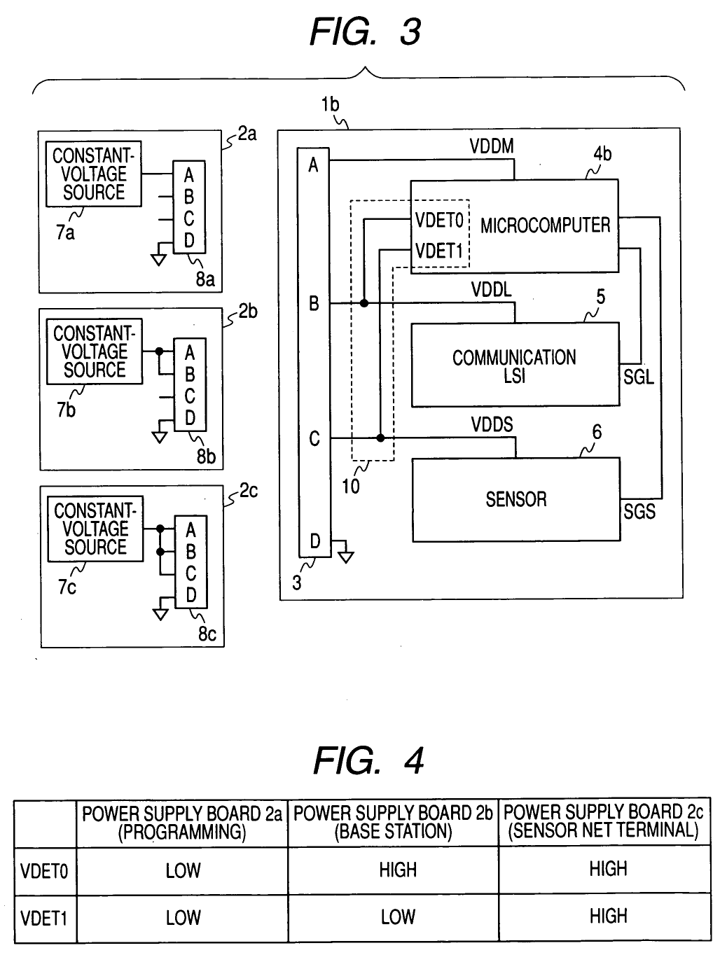

A second embodiment of the invention is related to the sensor net terminal (SNN) 100, and the base station (ACP) 200, shown in FIG. 1. In FIG. 3, parts corresponding to those of the first embodiment, shown in FIG. 1, are denoted by like reference numerals, thereby omitting description thereof.

FIG. 3 is a block diagram showing the structure of a base station (ACP) 200 as well as a sensor net terminal (SNN) 100, according to the second embodiment of the invention. As shown in FIG. 3, the present embodiment has a feature in that a microcomputer 4b of a terminal device 1b is provided with a power supply voltage determination means 10. The power supply voltage determination means 10 comprises digital input terminals VDET0, VDET1 of the microcomputer 4b, connected to terminals B, C of a connecter 3, respectively. VDET0, VDET1 are connected to respective power supply lines VDDL, VDDS to a communication LSI 5, and a sensor 6. VDET0, VDET1 being the digital input terminals, the microcomputer 4b is able to find respective voltages of VDDL, VDDS, as logic levels, by referring to the respective terminals.

Now, the respective structures of power supply boards 2a, 2b, 2c are known beforehand. In the case of connecting the respective power supply boards to the connecter 3 of the terminal device 1b, the respective logic levels of VDET0, VDET1 of the power supply voltage determination means 10 will be as shown in FIG. 4. More specifically, when the power supply board 2a corresponding to the program-write mode is connected to the terminal device 1b, the terminals B, C of the connecter 3 are not connected to the constant-voltage source 7a, so that both VDET0, and VDET1 are Low. When the power supply board 2b corresponding to the base station mode is connected to the terminal device 1b, the terminal B of the connecter 3 is connected to the constant-voltage source 7b, and the terminal C is not connected to the constant-voltage source 7b, so that VDET0=High, and VDET1=Low. When the power supply board 2c corresponding to the sensor net terminal mode is connected to the terminal device 1b, the terminals B, C of the connecter 3 are connected to the constant-voltage source 7c, so that both VDET0, and VDET1 are High.

Accordingly, the microcomputer 4b examines the respective logic levels of VDET0, VDET1 of the power supply voltage determination means 10 to determine which state in FIG. 4 the power supply board matches., thereby easily finding a power supply voltage, and a delivery range of the power supply voltage.

In an operation program of the microcomputer 4b, there are provided the respective logic levels of VDET0, VDET1 of the power supply voltage determination means 10, corresponding to the power supply boards 2a, 2b, 2c, respectively, as shown in FIG. 4, and in case that a wrong power supply board against any of the operation modes is connected to the terminal device 1b, the microcomputer 4b stops operation by keeping signal lines SGL, SGS for connecting the microcomputer 4b to the communication LSI 5, and the sensor 6, respectively, at Low level, in order to prevent a high-voltage signal from the microcomputer 4b from being inputted to other processing units, resulting in destruction of the same.

As described in the foregoing, by connecting the power supply boards 2a, 2b, 2c to the terminal device 1b via the connecter 3 and the connecters 8a, 8b, 8c, it is possible to change over between the respective processing units of the terminal device 1a, to which power supply is delivered from the power supply boards 2a, 2b, 2c, respectively, and the voltage levels of the power supply as delivered. Hence, the base station (ACP) 200 as well as the sensor net terminal (SNN) 100 can be implemented by adoption of the same hardware structure, and by interchanging the power supply boards 2a, 2b, 2c, it is possible to effect changeover between the sensor net terminal (SNN) 100, and the base station (ACP) 200. Further, by requiring changeover among the power supply boards to effect changeover between the power supplies to deliver power, and by use of the power supply voltage determination means 10, it becomes possible to find the power supply voltages being delivered to the respective processing units, and a delivery range of the power supply voltages without causing increase in a device configuration, thereby preventing the voltage level from being delivered to a wrong processing unit.

### Embodiment 3

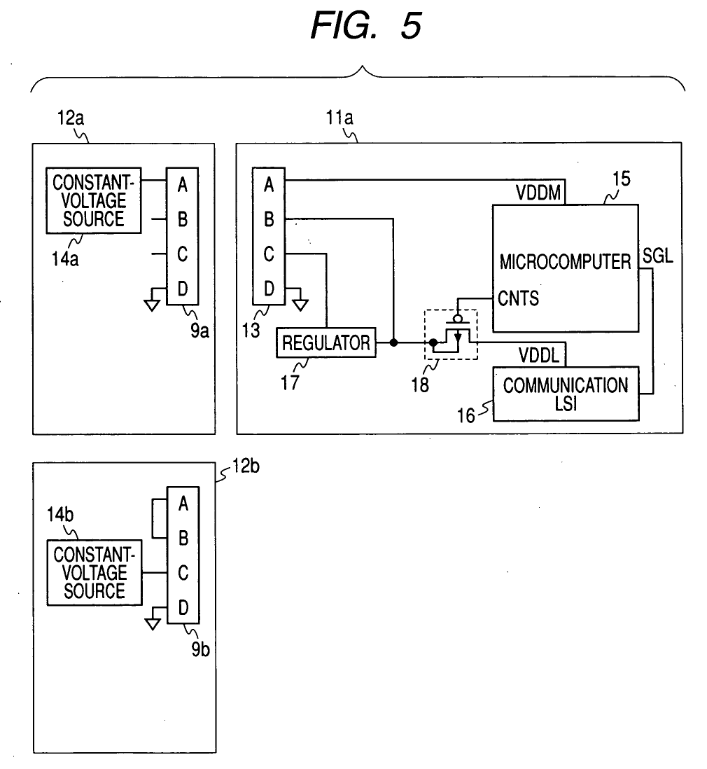

A third embodiment of the invention is related to a sensor net terminal (SNN) 100. Description on parts of a configuration thereof, identical to those of the first embodiment, is omitted. FIG. 5 is a block diagram showing the third embodiment of the invention. As shown in FIG. 5, a terminal device 11a according to the invention is provided with a connecter 13, a regulator 17, a power supply switch 18, and a plurality of processing units. With the present embodiment, there is described the terminal device provided with two processing units of a microcomputer 15, and a communication LSI 16, as the plurality of the processing units, however, the invention is not limited in its configuration to the two processing units. A signal line SGL is connected from the microcomputer 15 to the communication LSI 16. The connecter 13 comprises four terminals A, B, C, D. A power supply line VDDM of the microcomputer 15 is connected to the terminal A of the connecter 13. A power supply line VDDL of the communication LSI 16 is connected to the terminal B of the connecter 13, and an output terminal of the regulator 17 via the power supply switch 18. The regulator 17 is inserted between the terminal C of the connecter 13, and the power supply switch 18. The ground potential of the terminal device 11a is connected to the terminal D of the connecter 13. The power supply switch 18 is for executing control of a power supply to the communication LSI 16 by controlling a terminal CNTS of the microcomputer 15, and if CNTS=Low, power supply is delivered to the communication LSI 16 while if CNTS=High, delivery of the power supply to the communication LSI 16 is blocked.

Power supply boards 12a, 12b are provided with connecters 9a, 9b, and constant-voltage sources 14a, 14b, respectively. For the constant-voltage sources 14a, 14b, respectively, use is made of, for example, a constant-voltage source outputting 3V. The connecters 9a, 9b each comprise four terminals A, B, C, D as with the case of the connecter 13. The respective terminals D of the connecters 9a, 9b are connected to the respective ground potentials of the power supply boards 12a, 12b. Further, parts to which the remaining terminals A, B, C are connected, respectively, differ between the power supply boards 2a, 2b. As shown in FIG. 5, with the power supply board 12b, the terminals A, B are short-circuited, and the terminal C is connected to the constant-voltage source 14b. With the power supply board 12a, the terminal A is connected to the constant-voltage source 14a, and the terminals B, C are open-ended.

The connecter 13 is connected to only one of connecters 9a, 9b at a time. Accordingly, it is only one of the power supply boards 12a, 12b that can be connected to the terminal device 11a at a time. The terminals A, B, C, D of the connecter 13 are connected to the terminals A, B, C, D of the connecters 9a, 9b, respectively, on an one-on-one basis.

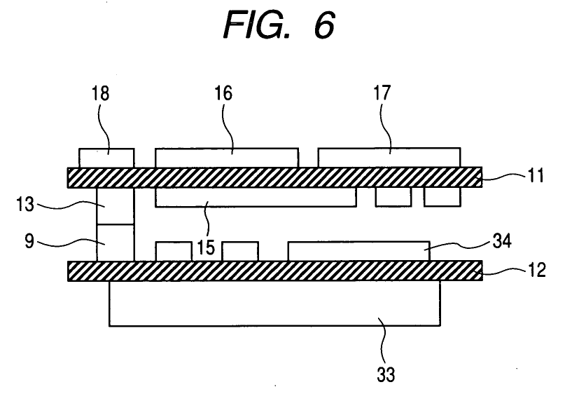

FIG. 6 shows a structure of the sensor net terminal (SNN) 100. As shown in FIG. 6, there are mounted the connecter 13, the microcomputer 15, the communication LSI 16, the regulator 17, the power supply switch 18, and other components on either surface of a substrate of the terminal device 11. Further, there are mounted the connecter 9, a battery 33 as the constant-voltage source 14, the regulator 34, and other components on either surface of the power supply board 12. Upon connection of the connecter 13 with the connecter 9, the power supply board 12 and the terminal device 11 are disposed so as to form a layered structure as shown in FIG. 6. As there will be no need for providing the power supply board with a plurality of power supplies if a terminal is designed on the basis of a configuration according to the present embodiment, it is possible to design the power supply board 12 to reside in an area equivalent in size to the terminal device 11, so that the terminal device 11, and the power supply board 12 can be disposed so as to form the layered structure, thereby attaining miniaturization.

The power supply boards 12a, 12b are power supply boards corresponding to respective operation modes of the terminal device 11a. By interchanging the power supply boards for every operation mode, it is possible to change over between delivery of the power supply of the respective constant-voltage sources 14a, 14b of the power supply boards 12a, 12b to processing units of the terminal device 11a, or delivery of the power supply via the regulator 17 to the processing units of the terminal device 11a. With the present embodiment, the operation modes are two modes including the program-write mode, and the sensor net terminal mode. The power supply boards 12a, 12b are the power supply boards for the program-write mode, and for the sensor net terminal mode, respectively. The program-write mode is a mode for writing to a nonvolatile memory embedded in the microcomputer 15. Accordingly, in the program-write mode, it is sufficient for power supply to be supplied only to the microcomputer 15 among the processing units of the terminal device 11a, and a voltage necessary for program-writing is 3V. The sensor net terminal mode is a mode for operating the terminal device 11a as the sensor net terminal for detecting information, and transmitting data on the information to the base station. Accordingly, the power supply is required for all the processing units of the terminal device 11a. In order to aim at low power consumption, an operation voltage for the sensor net terminal mode is 1.8V.

Next, there are described respective voltages of the processing units when the power supply boards 12a, 12b are connected to the terminal device 11a, respectively. In the case of connecting the power supply board 12a to the terminal device 11a, the power supply voltage 3V is delivered from the constant-voltage source 14a to the microcomputer 15 via the respective terminals A of the connecters 13, 9a. Since the constant-voltage source 14a is not connected to the terminals B, C of the connecter 9a, no power supply is delivered to the communication LSI 16. In the case of using the power supply board 12a, power supply from the power supply board 12a is delivered to the processing units, and an output voltage of the regulator 17 inside the terminal device 11a is not delivered to the processing units. In the case of connecting the power supply board 12b to the terminal device 11a, the power supply voltage 3V is delivered from the constant-voltage source 14b to the regulator 17 via the respective terminals C of the connecters 13, 9b. Upon receiving the power supply voltage 3V, the regulator 17 outputs a voltage at 1.8V to the terminal B of the connecter 13 while outputting the voltage at 1.8V as a power supply VDDL to the communication LSI 16 via the power supply switch 18. Since the terminals A, and B of the connecter 9b are connected to each other inside the power supply board 12b, the voltage 1.8V outputted to the terminal B of the connecter 13 is outputted as it is to the terminal A of the connecter 13 via the power supply board 12b. Then, the voltage at the terminal A of the connecter 13 is delivered as a power supply VDDM to the microcomputer 15. Accordingly, in the case of using the power supply board 12b, the power supply voltage 1.8V is delivered to the microcomputer 15, and the communication LSI 16.

As described in the foregoing, by connecting the power supply boards 12a, 12b, having the configuration according to the present embodiment, to the terminal device 11a via the connecter 13, and the connecters 9a, 9b, respectively, it is possible to change over between the delivery of the power supply from the constant-voltage sources 14a, 14b of the power supply boards 12a, 12b, respectively, and the delivery of the power supply via the regulator 17, so that a range of the power supplies delivered to the respective processing units of the terminal device 11a, and voltages levels of the power supplies can be changed over. Further, by requiring changeover between the power supply boards to effect changeover between the power supplies delivering power, it becomes possible to prevent the voltage level from being delivered to a wrong processing unit without causing increase in a device configuration.

### Embodiment 4

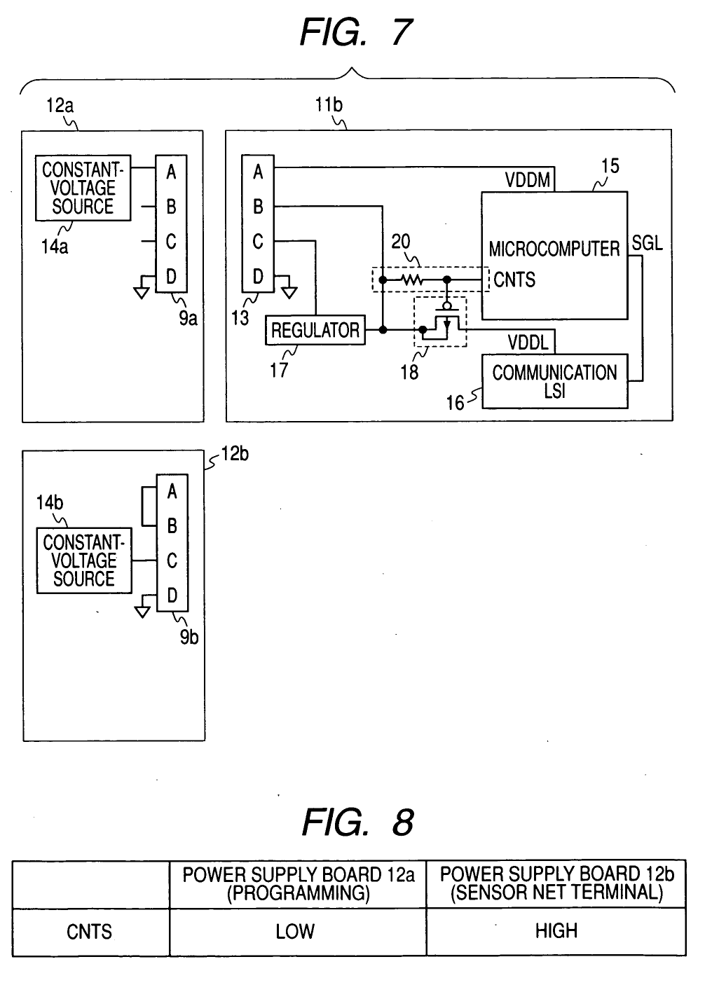

A fourth embodiment of the invention has a feature in that a sensor net terminal according to the fourth embodiment has a configuration identical to that for the third embodiment except that a power supply voltage determination means 20 is added thereto. FIG. 7 is a block diagram showing the sensor net terminal according to the fourth embodiment of the invention. In the figure, parts corresponding to those in FIG. 5 are denoted by like reference numerals, thereby omitting description thereof. The power supply voltage determination means 20 comprises a terminal CNTS of a microcomputer 15, and a resistor inserted between the terminal CNTS, and a terminal B of a connecter 13. The terminal CNTS is connected to a power supply line VDDL of a communication LSI 16 via the resistor, and is capable of finding a voltage of the a communication LSI 16 as a logic level of the terminal CNTS. The reason why the resistor is inserted between the terminal CNTS, and the terminal B of the connecter 13 is that a microcomputer terminal for determining a power supply voltage can be used in common with a control signal terminal of a power supply switch 18. That is, at the time of determining the power supply voltage, the terminal CNTS is set to an input terminal while at the time of controlling the power supply switch, the terminal CNTS is set to an output terminal, in which case, there otherwise occurs competition between an output of a regulator 17 and an output from the terminal CNTS, and the resistor is inserted to avoid such competition.

Now, respective structures of power supply boards 12a, 12b are known beforehand. Accordingly, in the case of connecting the respective power supply boards to the connecter 13 of the terminal device 11b, logic levels of the terminal CNTS of the power supply voltage determination means 20 will be as shown in FIG. 8. More specifically, when the power supply board 12a corresponding to the program-write mode is connected to the terminal device 11b, the terminal B of the connecter 13, and the terminal C serving as the power supply of the regulator 17 are not connected to a constant-voltage source 14a, so that CNTS is determined as Low. On the other hand, when the power supply board 12b corresponding to the sensor net terminal mode is connected to the terminal device 11b, the terminal C of the connecter 13, is connected to a constant-voltage source 14b, so that the regulator 17 outputs 1.8V to be then inputted to the terminal CNTS. Since at this point in time, 1.8V is inputted to the power supply of the microcomputer 15, the logic level of the terminal CNTS is determined as high.

Thus, the microcomputer 15 examines the logic level of CNTS of the power supply voltage determination means 20 to determine which state the power supply board matches, thereby easily finding a power supply voltage, and a delivery range of the power supply voltage.

In an operation program of the microcomputer 15, there are provided the logic levels of the power supply voltage determination means 20, corresponding to the power supply boards 12a, 12b, respectively, as shown in FIG. 7, and in case that a wrong power supply board against any of the operation modes is connected to the terminal device 11b, the microcomputer 15 stops operation by keeping a signal line SGL connecting the microcomputer 15 to the communication LSI 16 at Low level, in order to prevent a high-voltage signal from the microcomputer 15 from being inputted to other processing units, resulting in destruction of the same.

Thus, by use of the power supply voltage determination means 20, it becomes possible to find the power supply voltages delivered to the respective processing units and the delivery range of the power supply voltages without causing increase in a device configuration, thereby preventing the voltage level from being delivered to a wrong processing unit.

What is claimed is:

1. A terminal device comprising:
a connecter for connecting power supply boards for delivering respective power supply voltages thereto;
a plurality of processing units to be operated by the respective power supply voltages delivered from the power supply boards,
wherein by connecting the respective power supply boards differing in circuit structure from each other with the connecter, the processing units to which the respective power supply voltages are delivered and levels of the respective power supply voltages as delivered are changed over.

2. The terminal device according to claim 1,
wherein the power supply board and the terminal device are disposed so as to form a layered structure via the connecter.

3. The terminal device according to claim 1,
wherein the processing units comprises a controller; and a communication controller,
wherein the terminal device is provided with a regulator, and depending on the power supply board connected to the terminal device, and
wherein a change is made such that either a power supply voltage delivered via the regulator is delivered to the controller and the communication controller, or a power supply voltage delivered not through the medium of the regulator is delivered to the controller.

4. The terminal device according to claim 3,
wherein the controller detects a voltage level of an input line to the communication controller, and
wherein the controller executes a normal operation if the voltage level is high, and executes program-writing if the voltage level is low.

5. The terminal device according to claim 3,
wherein one of the power supply boards is provided with a constant-voltage source, and is connected to an input line to the controller via the connecter, thereby delivering a voltage level of the constant-voltage source to the controller.

6. The terminal device according to claim 3,
wherein one of the power supply boards is provided with a constant-voltage source, and is connected to an input line to the regulator via the connecter, and
wherein, by receiving an input from an output line of the regulator and connecting the input to an input line to the controller, the one of the power supply boards delivers a power supply voltage level lower than a voltage level of the constant-voltage source to the controller and the communication controller.

7. The terminal device according to claim 1,
wherein the processing units comprises a microcomputer; a communication controller; and a sensor, and
wherein, by changing the power supply board to be connected to the connecter, changeover is made among operation modes for delivering the power supply voltage only to the microcomputer, delivering the respective power supply voltages only to the microcomputer and the communication controller, and delivering the respective power supply voltages to the microcomputer, the communication controller, and the sensor, respectively.

8. The terminal device according to claim 7,
wherein the microcomputer has a power supply voltage determinator for the communication controller and the sensor, thereby determining a delivery mode of the power supply board, and stopping an operation thereof in case that the delivery mode of the power supply board does not match the operation mode of the microcomputer.

9. A terminal device comprising:
a controller operated by a power supply voltage as delivered; and
other processing units,
wherein the controller detects voltage levels of respective input lines to the other processing units, and executes a normal operation if the voltage levels are high while executing program-writing if the voltage levels are low.

10. A terminal device comprising:
at least two types of power supply boards; and
a terminal body connected to said at least two types of power supply boards, respectively via a single connector,
wherein the terminal body comprises a plurality of processing units,
wherein said at least two types of power supply boards differ from each other in that interconnections between power supplies respectively being inside said at least two types of power supply boards and the single connector differ from each other, and
wherein, by connecting either of said at least two types of power supply boards to the connector, a varying power supply voltage level is selectively delivered to the plurality of the processing units, respectively.
